(19) United States
(12) Patent Application Publication
(10) Pub. No.: US 2009/0096862 A1
(43) Pub. Date: Apr. 16, 2009

(54) Method of web application with broadcast

(76) Inventors: Steve Bogolea, Archer, FL (US); Darrin Stock, Denver, FL (US)

Correspondence Address: LAW OFFICE OF DALE B. HALLING, 3595 FOUNTAIN BOULEVARD SUITE A2, COLORADO SPRINGS, CO, 80910, US

(21) Appl. No.: 12/284,889

(22) Filed: Sep. 25, 2008

Related U.S. Application Data
(60) Provisional application No. 60/995,181, filed on Sep. 25, 2007.

(51) Int. Cl. H04N 7/14

(52) U.S. Cl. 348/14.12; 348/E07.078

(57) ABSTRACT

The invention is directed to a method of web application with broadcast that includes the steps of receiving a broadcast request at a broadcast coordinator from a customer computer. The broadcast request includes a telephone number. A video message is transmitted to the customer computer. An audio message is transmitted to a telephone at the telephone number. The video message and the audio message are synchronized. When the video message is completed, the telephone is connected to a second telephone. This method connects the customer to a person at the business. In addition, this method allows an advertisement to be played over the customer's computer and telephone while the call is being placed to the business.

### RELATED APPLICATIONS

The present invention claims priority on provisional patent application Ser. No. 60/995,181, filed on Sep. 25, 2007, entitled “Web Application with Broadcast” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

The world wide web has become an important marketing tool for many businesses. Business often have methods for their customer to contact them on their webpage. Commonly these webpages have an email form that the customer can send to the business to request additional information or service. Unfortunately, these emails are not real time and the customer is often frustrated in being contacted hours later or the next day by the business.

Thus, there exists a need for a more effective way for customers and businesses to communicate when the customer is viewing a business' website.

### BRIEF SUMMARY OF INVENTION

A method of web application with broadcast that overcomes these and other problems includes the steps of receiving a broadcast request at a broadcast coordinator from a customer computer. The broadcast request includes a telephone number. A video message is transmitted to the customer computer. An audio message is transmitted to a telephone at the telephone number. The video message and the audio message are synchronized. When the video message is completed, the telephone is connected to a second telephone.

### BRIEF DESCRIPTION OF THE SEVERAL VIEWS OF THE DRAWINGS

FIG. 1 is a block diagram of a system for a web application with broadcast in accordance with one embodiment of the invention;

FIG. 2 is a flow chart of the steps in a method of web application with broadcast in accordance with one embodiment of the invention;

FIG. 3 is a flow chart of the steps in a method of web application with broadcast in accordance with one embodiment of the invention;

FIG. 4 is a block diagram of a system for a web application with broadcast in accordance with one embodiment of the invention; and

FIG. 5 is a flow chart of the steps in a method of web application with broadcast in accordance with one embodiment of the invention.

### DETAILED DESCRIPTION OF THE INVENTION

The invention is directed to a method of web application with broadcast that includes the steps of receiving a broadcast request at a broadcast coordinator from a customer computer. The broadcast request includes a telephone number. A video message is transmitted to the customer computer. An audio message is transmitted to a telephone at the telephone number. The video message and the audio message are synchronized. When the video message is completed, the telephone is connected to a second telephone. This method connects the customer to a person at the business. In addition, this method allows an advertisement to be played over the customer's computer and telephone while the call is being placed to the business.

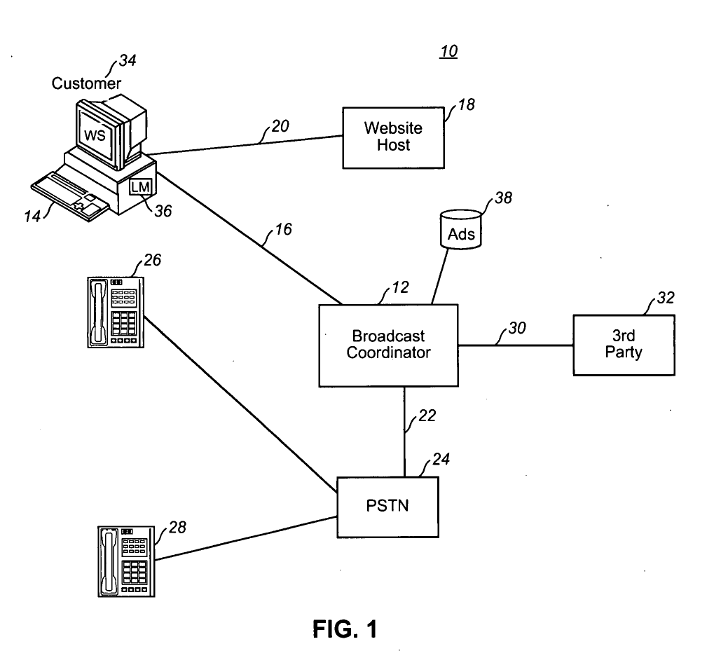

FIG. 1 is a block diagram of a system 10 for a web application with broadcast in accordance with one embodiment of the invention. The system 10 has a broadcast coordinator 12, which may be a software application running on a computer. The broadcast coordinator 12 is connected to a customer computer 14 over the internet 16 or other computer network. The customer computer 14 is connected to a host for a website 18 over the internet 20. The broadcast coordinator 12 is also connected 22 to the PSTN (Public Switched Telephone Network) 24. The PSTN 24 is connected to a customer telephone 26 and a business telephone number 28. The broadcast coordinator 12 is also connected 30 to a third party computer 32.

In one embodiment, a customer 34 is viewing a webpage on their computer 14. The webpage is stored on the website host 18 and belongs to a business. The webpage has a call me button 36 and the customer 34 clicks on the call me button because they want additional information from the business. The customer then provides their name and telephone number. By clicking on the call me button 36 a call me message is sent to the coordinator 12 that causes the coordinator to select a video and audio message from the advertisements database 38. The coordinator 12 sends the video message over the internet 16 to the customer's computer 14 and the audio message is sent over the PSTN 24 to the customer's telephone 26. Note that the PSTN 24 may also encompass/include a cellular telephone network. Note that the customer has to enter their name and telephone number when they select the call me button 36. The coordinator 12 synchronizes the audio and video message even though they are sent over different networks. (How does the coordinator do this?) When the messages (advertisement) is finished the coordinator 12 causes the customer telephone 26 to be connected to a business telephone 28. The business telephone 28 is owned by the same entity as the website. The coordinator 12 can determine that the customer 34 received the advertisement and logs the originating website 18, the date, the time, the phone number, the name of the customer and other data. This data is sent in a message received verification notice to a third party 32. The third party 32 is commonly the entity that created the advertisement the customer 34 received.

In one example, the website is a car dealer's website. The customer 34 is searching online for an automobile. The customer 34 has a question and hits the call me button 36. The customer 34 receives an advertisement from an automobile insurance company for example. Then when the advertisement is finished, the customer 34 is connected to the auto dealer's sales department 28. The automobile insurance company receives a message that their advertisement has been viewed and information about the viewing, such as the person's name, telephone number, originating website, time, date, etc.

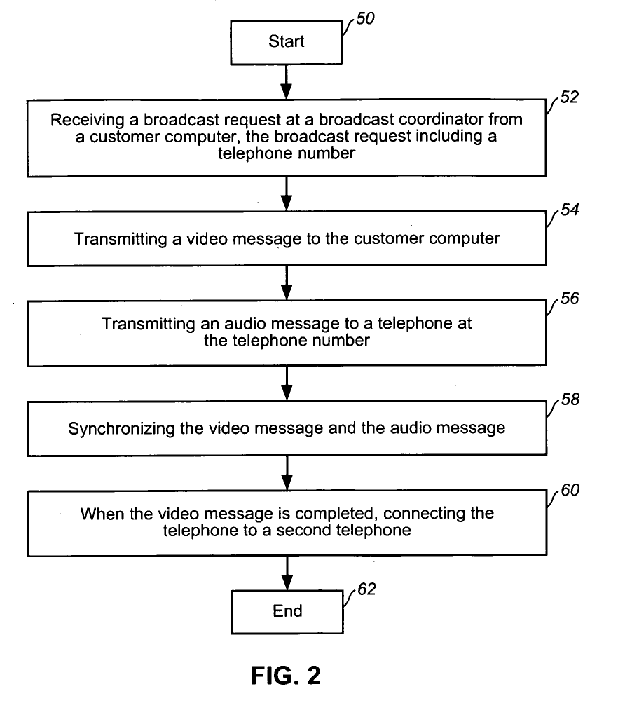

FIG. 2 is a flow chart of the steps in a method of web application with broadcast in accordance with one embodiment of the invention. The process starts, step 50, by receiving a broadcast request at a broadcast coordinator from a customer computer. The broadcast request includes a telephone number at step 52. A video message is transmitted to the customer computer at step 54. An audio message is transmitted to the customer telephone at step 56. The coordinator synchronizes the video and audio message at step 58. When the video message is complete at step 60, the customer telephone is connected to a second telephone which ends the process at step 62. Commonly the second telephone is a business sales or customer service telephone.

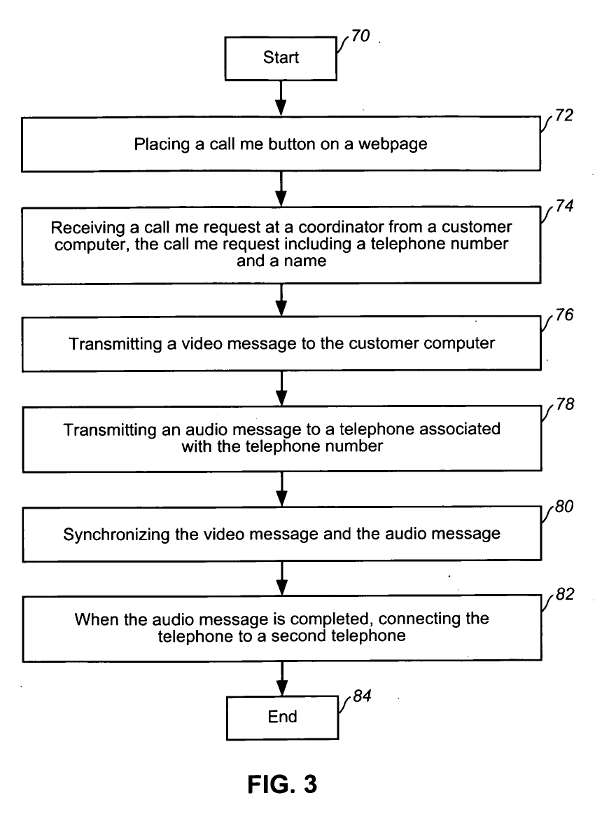

FIG. 3 is a flow chart of the steps in a method of web application with broadcast in accordance with one embodiment of the invention. The process starts, step 70, by placing a call me button on a webpage at step 72. A call me request is received at a coordinator from a customer computer at step 74. The call me request includes a telephone number and name of the customer. A video message is transmitted to the customer computer at step 76. An audio message is transmitted to the customer telephone at step 78. The coordinator synchronizes the video and audio message at step 80. When the audio message is completed at step 82, the telephone is connect to a second telephone which ends the process at step 84. Note that the second telephone number is a telephone number associated with the business that owns the webpage.

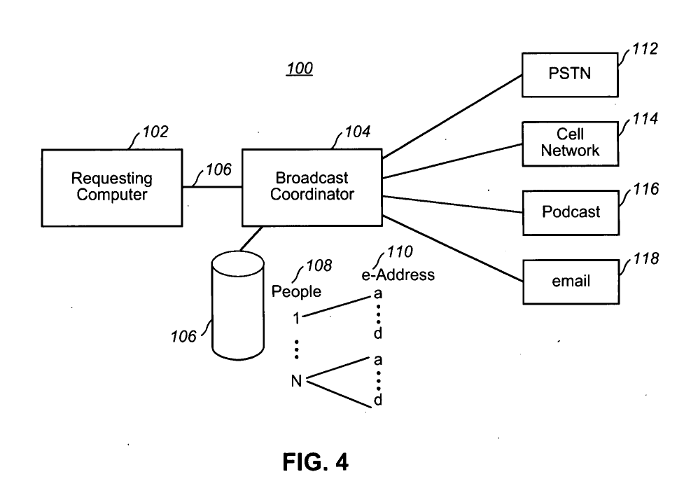

FIG. 4 is a block diagram of a system 100 for a web application with broadcast in accordance with one embodiment of the invention. This system 100 is almost the same as that shown in FIG. 1, but it has been reconfigured slightly to create a super reverse 911 system. The system 100 has a requesting computer 102 that is connected to a broadcast coordinator 104 by a network 106. The network 106 could be a local network or the internet or in one embodiment, the coordinator 104 and the requesting computer 102 could be the same computer. The broadcast coordinator 104 is connected to a database 106. The database has a list or lists of people 108 and for each person one or more electronic addresses 110. Note the coordinator 104 could select all the people 108 on the list or some subset thereof to send a broadcast message. The electronic addresses 110 may includes telephone numbers, both landlines and cellular (satellite) telephone numbers, handheld/portable electronic device addresses, email address or other personal electronic addresses. The broadcast coordinator 104 is coupled to the PSTN 112, cellular network 114, podcast network 116, email network 118 or other electronic network.

An example of how this system 100 can be used as a reverse 911 system is to alert a neighborhood of an escaped convict in their neighborhood. The police send a broadcast request from their computer 102 to the coordinator 104. The coordinator 104 looks up the people 106 in the effected neighborhood. The electronic addresses 110 of the people 108 in the neighborhood are determined and used to transmit a message to each of their electronic addresses 110. The coordinator 104 determines if the broadcast message is received at any of a person's electronic addresses. When the broadcast message has not been received, the coordinator 104 retransmits the broadcast message to all the person's electronic addresses until the coordinator 104 can verify the message was received. In this way a person can be contacted by phone, podcast, email, etc. The person does not have to monitor a general broadcast station to receive this vital information. Note that the people in the neighborhood do have to provide access to their electronic addresses.

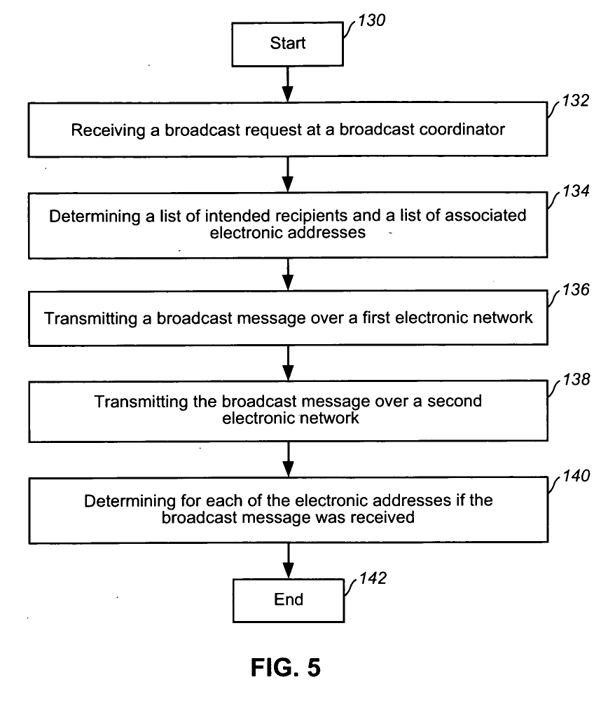

FIG. 5 is a flow chart of the steps in a method of web application with broadcast in accordance with one embodiment of the invention. The process starts, step 130, by receiving a broadcast request at a broadcast coordinator at step 132. A list of intended recipients is determined and a list of associated electronic addresses at step 134. A broadcast message is transmitted over a first electronic network at step 136. The broadcast message is transmitted over a second electronic network at step 138. For each of the electronic addresses it is determined at step 140 if the broadcast message was received which ends the process at step 142. In one embodiment, when the broadcast message was not received at the electronic address, an intended recipient of the broadcast message is determined. Next it is determined if the intended recipient received the broadcast message at an alternative electronic address. When the intended recipient did not receive the broadcast message at the alternative electronic address, the broadcast message is retransmitted at the electronic address.

Thus there has been described a more effective way for customers and businesses to communicate when the customer is viewing a businesses website.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A method of web application with broadcast, comprising the steps of:
receiving a broadcast request at a broadcast coordinator from a customer computer, the broadcast request including a telephone number;
transmitting a video message to the customer computer;
transmitting an audio message to a telephone at the telephone number;
synchronizing the video message and the audio message; and
when the video message is completed, connecting the telephone to a second telephone.

2. The method of claim 1, wherein the step of receiving the broadcast request includes the step of a customer selecting a contact me button on a website displayed on the customer computer.

3. The method of claim 1, wherein the step of receiving the broadcast request includes the step of determining a time, a date and an originating website of the broadcast request.

4. The method of claim 3, further including the step of transmitting a message received verification notice to a third party.

5. The method of claim 4, wherein the message received verification notice includes the time, the date and the originating website.

6. The method of claim 5, wherein the message received verification notice also includes the telephone number and a name of an originating customer.

7. A method of web application with broadcast, comprising the steps of:
receiving a broadcast request at a broadcast coordinator;
determining a list of intended recipients and a list of associated electronic addresses;
transmitting a broadcast message over a first electronic network;
transmitting the broadcast message over a second electronic network;
determining for each of the electronic addresses if the broadcast message was received.

8. The method of claim 7, further including the step of when the broadcast message is completed, connecting a first telephone to a second telephone.

9. The method of claim 8, wherein the step of receiving the broadcast request includes the step of a customer selecting a contact me button on a website displayed on a customer computer.

10. The method of claim 9, wherein the step of receiving the broadcast request includes the step of determining a time, a date and an originating website of the broadcast request.

11. The method of claim 7, wherein the step of transmitting the broadcast message over the first electronic network includes the step of selecting a public switch telephone network to be the first electronic network.

12. The method of claim 7, wherein the step of transmitting the broadcast message includes the step of selecting a podcast as the broadcast message.

13. The method of claim 7, further including the steps of:
when the broadcast message was not received at the electronic address, determining an intended recipient of the broadcast message;
determining if the intended recipient received the broadcast message at an alternative electronic address;
when the intended recipient did not receive the broadcast message at the alternative electronic address, retransmitting the broadcast message at the electronic address.

14. The method of claim 7, wherein the step of transmitting the broadcast message over the second electronic network, includes the step of transmitting the broadcast message by email.

15. A method of web application with broadcast, comprising the steps of:
placing a call me button on a webpage;
receiving a call me request at a coordinator from a customer computer, the call me request including a telephone number and a name;
transmitting a video message to the customer computer;
transmitting an audio message to a telephone associated with the telephone number;
synchronizing the video message and the audio message; and
when the audio message is completed, connecting the telephone to a second telephone.

16. The method of claim 15, wherein the step of connecting the telephone to the second telephone, includes the step of determining a telephone number associated with the web page.

17. The method of claim 15, further including the step of storing a time, a date and the webpage.

18. The method of claim 17, further including the step of transmitting a message received verification notice to a third party.

19. The method of claim 18, wherein the transmitting the message received verification notice to the third party includes the step of determining the third party associated with the video message.

20. The method of claim 19, the owner of the web page is not the third party.
